(19) United States
(12) Patent Application Publication
(10) Pub. No.: US 2011/0017242 A1
(43) Pub. Date: Jan. 27, 2011

(54) Roller cleaning bucket

(76) Inventors: Anthony S. Fiorino, Woodstock, MD (US); Victor S. Fiorino, Woodstock, MD (US)

Correspondence Address: RUTH EURE, 4795 EDISON AVENUE, BOULDER, CO, 80301, US

(21) Appl. No.: 12/804,468

(22) Filed: Jul. 22, 2010

Related U.S. Application Data
(60) Provisional application No. 61/227,572, filed on Jul. 22, 2009.

(51) Int. Cl. B08B 3/00

(52) U.S. Cl. 134/34

(57) ABSTRACT

The Roller Cleaning Bucket provides an apparatus that can clean paint rollers so a user does not have to employ their hands for the messy task. This device comprises a standard plastic, five-gallon bucket with a water supply, a discharge tube and a paint roller holder. Inside the bucket are two waterspouts designed specifically to clean paint rollers and brushes. The handle holding the roller may be temporarily mounted to the bucket by use of the external clip for this purpose. Water is supplied from a standard hose threaded to bifurcated PVC tubing that directs the water through the bifurcated inlet tube to contact the roller, causing it to spin. This deeply cleans the fibers and expels any paint residue. The water is directed through the inlet tube into a vertical cylindrical tube which comprises a row of perforations through which the water sprays onto the roller. The water pressure supplied by the household water supply provides enough pressure for the water to spray and cause the roller to spin.

### CLAIM OF PRIORITY

This patent application claims priority under 35 USC 119 (e) (1) from U.S. Provisional Patent Application Ser. No. 61/227,572 Jul. 22, 2010, of common inventorship herewith entitled, “Roller Cleaning Bucket.”

### FIELD OF THE INVENTION

The present invention pertains to the field of painting utensils, and more specifically to the field of painting by rollers, and even more specifically to the field of clean up of roller painting utensils.

### BACKGROUND OF THE INVENTION

The prior art has put forth several designs for cleaning paint rollers. Among these are:

U.S. Pat. No. 5,935,342 to Phillip B. Boyd describes a paint roller cleaner comprising a tubular body holding a paint roller, covered with a traversing nozzle spraying a liquid whereby the roller is cleaned after use.

U.S. Pat. No. 6,079,429 to Ennio Zarich describes a paint roller cleaner comprising a generally tubular housing having one end open and the other end tapered to join a faucet coupling adapted to be releasably secured to a water source. The diameter of the housing is dimensioned to receive the roller with minimum clearance therebetween for pressurized water flow.

U.S. Pat. No. 7,325,557 to Millard F. Wallace, III, describes a roller and paintbrush cleaning kit comprising a spindle adapted to hold a rotatable cylindrical paint pad, and an arm connecting the spindle to a handle. A semi cylindrical over curves about the roller's spindle. A liquid manifold is integral with the cover to deliver a curtain of liquid to the paint roller for washing the cylindrical pad.

None of these prior art references describe the present invention.

### SUMMARY OF THE INVENTION

It is an object of the present invention to provide an improved apparatus for cleaning paint rollers and paint brushes.

### BRIEF DESCRIPTION OF THE DRAWINGS

FIG. 1 is a top elevational view showing the internal structures of the bucket of the present invention.

FIG. 2 is a top elevational view showing the internal structures of the bucket of the present invention showing water being sprayed onto the paint roller.

FIG. 3 shows the outside of the bucket showing the clip for holding the paint roller in place during cleaning.

FIG. 4 is a front perspective view of the outside of the bucket of the present invention showing water supply inlets.

FIG. 5 shows a top elevational view showing the internal structures of the bucket of the present invention showing a paint roller and brush with water being sprayed onto the paint roller and water accumulating in the bottom of the bucket.

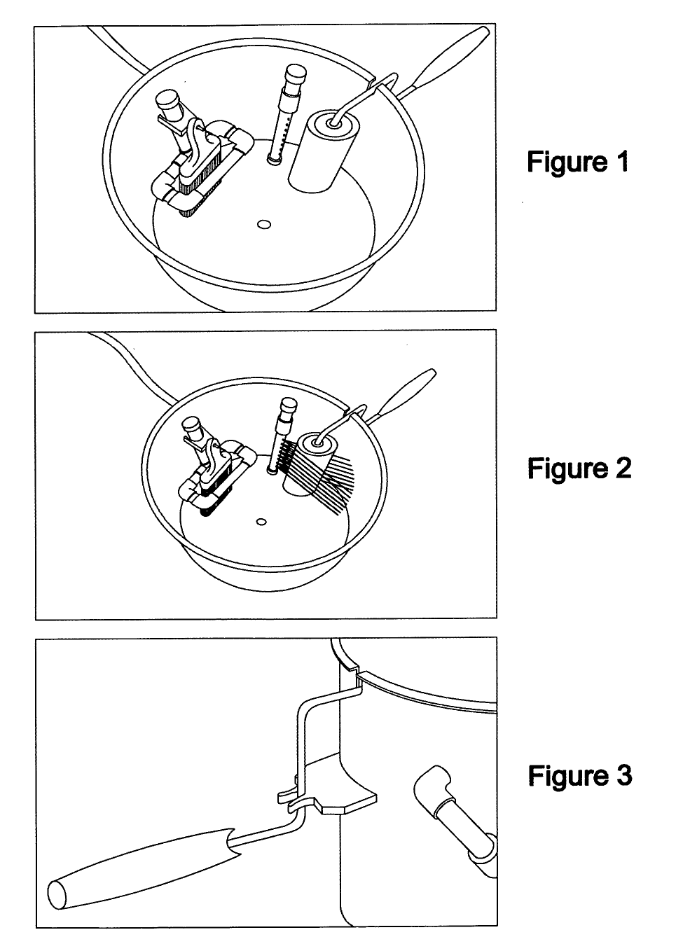

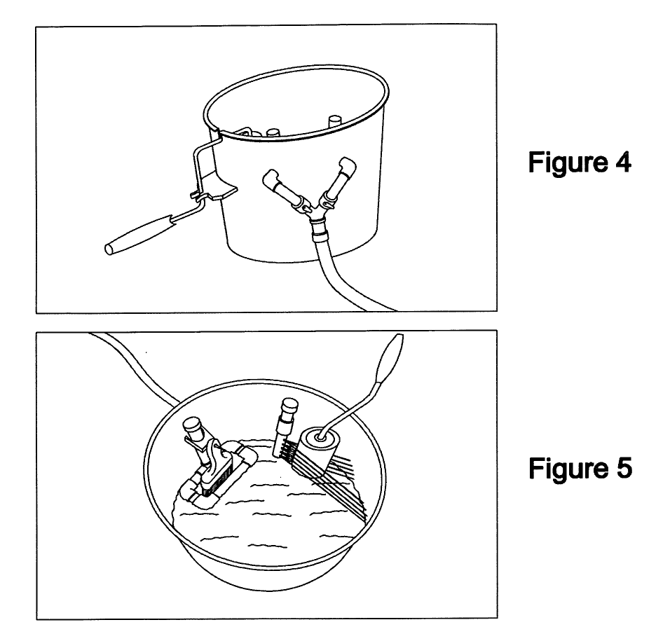

### DETAILED DESCRIPTION OF THE INVENTION

After painting, cleaning rollers can be an arduous and messy task. One may often have to wring out excess paint with their hands, which may allow plaint to splash on their body or temporarily stain their hands or clothing. Excess paint can easily discolor one's sink. Having a hands-free way to thoroughly clean paint rollers without creating a mess may assist individuals in completing the process in a timely fashion with little effort. The present invention provides such a device.

The present invention, hereinafter referred to as the Roller Cleaning Bucket is a device that can be utilized to quickly and efficiently clean paint from soaked rollers without creating a mess. This unique product can assist individuals in removing excess paint from rollers without having to touch the unclean items in the process. This innovative item is ideal for use in private residences as well as commercial establishments to effectively cleanse paint rollers without using one's hands.

The Roller Cleaning Bucket is an apparatus that can clean paint rollers so a user does not have to employ their hands for the messy task. This device comprises a standard plastic, five-gallon bucket with a water supply, a discharge tube and a paint roller holder. Inside the bucket are two waterspouts designed specifically to clean paint rollers and brushes. The handle holding the roller may be temporarily mounted to the bucket by use of the external clip for this purpose shown in FIG. 3. Water is supplied from a standard hose threaded to bifurcated PVC tubing that directs the water through the bifurcated inlet tube to contact the roller, causing it to spin. This deeply cleans the fibers and expels any paint residue. The water is directed through the discharge tube into a vertical cylindrical tube which comprises a row of perforations through which the water sprays onto the roller. The water pressure supplied by the household water supply provides enough pressure for the water to spray and cause the roller to spin.

The inside of the bucket also is equipped with a holder for a suspending a paint brush in the bucket so the brush can be cleaned by the same water used to clean the roller.

After use, the bucket may be used to store and transport paint supplies. This item may be available in various colors and sizes to accommodate user preferences and needs.

A drain hole is present in the bottom of the bucket to allow the drainage of dirty water.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A paint roller cleaning bucket comprising:
a) a bucket five-gallon bucket,
b) a water supply,
c) a discharge tube,
d) a paint roller holder mounted to the outside of the bucket,
e) a drain hole in the center of the bottom of the bucket, wherein the water supply is bifurcated into two waterspouts, designed specifically to clean paint rollers and brushes.

2. The bucket of claim 1, further comprising water directed through the discharge tube into a vertical cylindrical tube which comprises a row of perforations through which the water sprays onto the roller, and wherein the spray of water causes the roller to spin.

3. The bucket of claim 1 further comprising the inside of the bucket comprises a holder for a suspending a paint brush in the bucket.
